(19) United States
(12) Patent Application Publication
(10) Pub. No.: US 2020/0260715 A1
(43) Pub. Date: Aug. 20, 2020

(54) METHOD FOR A SPRAY DEVICE

(71) Applicant: Robert Bosch GmbH, Stuttgart (DE)

(72) Inventors: Bernd Stuke, Leonberg (DE); Helmut Schomburg, Deufringen (DE); Olaf Ohlhafer, Erligheim (DE); Steffen Sies, Rottenburg (DE); Hans-Arndt Freudigmann, Tuebingen (DE)

(73) Assignee: Robert Bosch GmbH, Stuttgart (DE)

(21) Appl. No.: 16/757,946

(22) PCT Filed: Oct. 19, 2018
(86) PCT No.: PCT/EP2018/078766

§ 371 Date: Apr. 21, 2020

(30) Foreign Application Priority Data
Nov. 10, 2017 (DE) 10 2017 220 020.0

(51) Int. Cl. A01M 7/00; B05B 12/00; B05B 12/10; B05B 7/32

(52) U.S. Cl. CPC A01M 7/0092; B05B 12/004; B05B 13/005; B05B 7/32; B05B 12/10

(57) ABSTRACT

A method for monitoring and/or adjusting an active agent concentration in a spray liquid to be deployed via a spray device for agricultural purposes, an active agent and a carrier liquid being fed to a mixing unit of the spray device in order to blend the spray liquid. The method includes: receiving a first property signal including a piece of property information of the blended spray liquid detected using a first sensor unit, to ascertain an actual value of the property information of the spray liquid; receiving a second property signal including the piece of property information of the supplied carrier liquid detected using a second sensor unit of the spray device to ascertain a base value of the property information of the carrier liquid; and outputting an information signal to a display unit and/or a control signal to a delivery unit of the spray device.

### FIELD

The present invention relates to a method for monitoring and/or adjusting an active agent concentration in a spray liquid to be deployed with the aid of a spray device, in particular, for agricultural purposes, an active agent and a carrier liquid being fed to a mixing unit of the spray device in order to blend the spray liquid, and a spray device. The present invention also relates to a control unit and a computer program.

### BACKGROUND INFORMATION

German Patent Application No. DE 10 2009 026 234 A1 describes a field sprayer including sensors for ascertaining and for adjusting an active agent concentration in a spray liquid. In this field sprayer, a sensor, which checks whether active agent is already situated or no active agent is situated in the carrier liquid, is situated in a section of the line feeding the carrier liquid to the system. If active agent should already be present in the carrier liquid, this sensor may then ascertain the concentration already present in the carrier liquid before the introduction of the active agent.

### SUMMARY

The present invention provides a method for monitoring and/or adjusting an active agent concentration in a carrier liquid to be deployed with the aid of a spray device, in particular, for agricultural purposes, an active agent and a carrier liquid being fed to a mixing unit of the spray device in order to blend the spray liquid. An example method in accordance with the present invention includes the steps:
receiving a first property signal including a piece of property information of the blended spray liquid detected with the aid of a first sensor unit, in order to ascertain an actual value of the property information of the spray liquid, an active agent concentration in the spray liquid being ascertainable using the property information;
receiving a second property signal including the piece of property information of the supplied carrier liquid detected with the aid of a second sensor unit of the spray device, in order to ascertain a base value of the property information of the carrier liquid; and
outputting an information signal to a display unit and/or a control signal to a delivery unit of the spray device as a function of the ascertained actual value of the property information of the spray liquid and as a function of the ascertained base value of the property information of the carrier liquid, in order to monitor and/or to adjust the active agent concentration in the blended spray liquid.

The present invention also includes an example control unit, which is configured to carry out all steps of a previously described method.

The present invention also includes a spray device for deploying a spray liquid, in particular, for agricultural purposes. An example spray device in accordance with the present invention includes:
a mixing unit for blending a spray liquid made up of a carrier liquid delivered to the mixing unit with the aid of a liquid delivery unit, and an active agent supplied with the aid of an active agent delivery unit;
a first sensor unit for detecting a piece of property information of the blended spray liquid, an active agent concentration in the spray liquid being ascertainable using the property information;
a second sensor unit for detecting a piece of property information of the supplied carrier liquid; and
a previously described control unit, in order to monitor and/or adjust the active agent concentration in the blended spray liquid.

Finally, the present invention includes an example computer program, which is configured to carry out all steps of a previously described method, as well as a machine-readable memory medium on which the computer program is stored.

An agricultural purpose is understood within the scope of the present invention to mean a purpose, which is directed to an economic cultivation of crop plants.

The spray device may, in particular, be part of an agricultural field sprayer or a plant protection device, or may be designed as an agricultural field sprayer or a plant protection device. The spray device may be attachable and/or attached on or at a mobile unit. The mobile unit may be designed as a farm vehicle and/or as an aircraft and/or as a trailer. The mobile unit may, in particular, be an agricultural machine, for example, a truck, a tractor or a (self-propelled or autonomous) field sprayer. The spray device may also be attached to a hydraulic device of the agricultural machine. It is also possible that the spray device is constructed on a loading platform of the agricultural machine. Alternatively, the spray device may be coupled to the agricultural machine.

The spray liquid in this case is preferably deployed on a field. A field in the present case may be understood to mean an agricultural area or an area utilized for agriculture, a cultivation acreage for plants or also a parcel of such an area or crop area. The field may thus be arable land, grassland or pasture land. The plants may include crop plants, for example, whose yield is utilized agriculturally (for example, as foodstuff, animal feed or as energy crop), as well as waste plants, weeds and grass weeds. The plants may be part of the agricultural area.

The term “spray liquid” within the scope of the present invention includes both the entire spray liquid as well as only a portion or fraction, in particular, a spatially limited portion or fraction of the spray liquid in the spray device. The spatially limited portion or fraction of the spray liquid may, for example, be the portion of spray liquid situated in a component (line, tank, valve, etc.) of the spray device.

The spray liquid includes at least one active agent. The active agent may include a “spraying agent,” i.e., a preparation or plant protection agent, in particular, a plant protection agent concentrate. Accordingly, the active agent may, for example, include an herbicide, fungicide or an insecticide (pesticide). The spray liquid may be a spray mixture. However, the active agent may also be a fertilizer, in particular, a fertilizer concentrate. Accordingly, the active agent may include a liquid fertilizer and/or a growth regulator. The active agent may be formed as a liquid or as a solid, for example, in the form of granulates or as a pre-dissolved solid, for example, in the form of pre-dissolved granulates.

The spray liquid further includes a carrier liquid for diluting the active agent. A carrier liquid may be understood within the scope of the present invention to mean a liquid, which is designed to be intermixed with the active agent in order to enable or improve a deployment or delivery of the active agent, for example, of the plant protection agent or of the fertilizer. It is also possible that an active agent is suspended as a solid or a granulate in the carrier liquid. It is further possible that a non-soluble active agent in the carrier liquid is emulsified in the carrier liquid. The carrier liquid is preferably water.

Accordingly, the spray liquid may be formed as: a liquid, suspension, emulsion, solution or a combination thereof. The spray liquid is designed preferably as a plant protection agent diluted with water or a fertilizer diluted with water.

The spray device preferably includes a spray liquid tank for accommodating the spray liquid and at least one spray nozzle unit for deploying the spray liquid. The spray liquid may be fed or conducted from the spray liquid tank to the spray nozzle unit with the aid of a spray liquid line or multiple spray liquid lines. A line or spray liquid line may be understood within the scope of the present invention to also mean a section of the corresponding line or of the spray liquid line. The line may be designed as fluidic connection line, for example, in the form of a pipe, hose, duct or a tube.

To mix the spray liquid, the spray device includes (in the flow direction of the spray liquid) a mixing unit upstream from the spray liquid tank, into which the liquid is fed or conducted from a liquid tank of the spray device, and the active agent from an active agent tank of the spray device. For this purpose, the spray device includes on the one hand a liquid delivery unit, which is designed to conduct or deliver the liquid from the liquid tank via a liquid line to the mixing unit in a targeted or defined manner. On the other hand, the spray device includes an active agent delivery unit for this purpose, which is designed to conduct or deliver the active agent from the active agent tank via an active agent line to the mixing unit in a targeted or defined or metered manner. The delivery units may include one or multiple metering units or metering components. The metering units or metering components may include one or multiple pumps or metering pumps and valves. At least one of the delivery units may be designed to generate the spray pressure at the spray nozzle unit, i.e., the pressure with which the spray liquid is deployed.

A mixing unit may be understood within the scope of the present invention to mean a unit, which is designed to intermix or blend, preferably as homogenously as possible, at least the carrier liquid and the active agent with one another to form the spray liquid. The mixing unit may include a mixing element or agitator element, in order to actively intermix the carrier liquid and the active agent with one another. The agitator element may be designed as an agitator blade or propeller. The mixing unit may include a mixing tank including at least one inlet each for the carrier liquid and for the active agent. This means in other words that the carrier liquid and the active agent may be fed separately, i.e., with the aid of separate lines, directly into the mixing unit or mixing tank. Alternatively, a shared inlet may be provided at the mixing unit in the form of a T-piece, the active agent being initially fed to the carrier liquid or introduced into the carrier liquid and subsequently fed together with the carrier liquid into the mixing unit. The mixing unit or the mixing tank may include at least one outlet for the intermixed or mixed spray liquid, for example, in a lower area. It is also possible that the mixing unit is designed as a static mixing unit or static mixer. The mixing unit may, however, also be designed only as a T-piece, so that a passive intermixing takes place in the mixing unit.

The mixing unit may also be integrated into the spray liquid tank. Accordingly, the spray liquid tank may be designed as a mixing tank of the mixing unit. The mixing element and/or agitator element in this case may be situated on or in the spray liquid tank, in order to intermix or blend the liquid spray.

The spray liquid tank may, however, also be situated in the spray liquid line downstream from the mixing unit. This means in other words that the spray liquid tank is situated in the flow direction of the spray liquid from the mixing unit to the spray nozzle unit behind or after the mixing unit. The spray liquid tank may thus be spatially situated in the spray liquid line between the mixing unit and the spray nozzle unit. The spray liquid tank may be designed as a buffer tank, so that the spray liquid is feedable or fillable from the mixing unit initially into the buffer tank and feedable or deliverable or conductable from the buffer tank to the spray nozzle unit as needed.

The spray device may also include a spray liquid delivery unit, which is situated in, and/or is integrated into, the spray liquid line downstream from the spray liquid tank or buffer tank. The spray liquid delivery unit may then be designed to conduct the spray liquid from the spray liquid tank or buffer tank under pressure or under a defined pressure to the spray nozzles or spray nozzle units. The spray liquid delivery unit may be designed, in particular, to generate a constant pressure, i.e., may be designed as a constant pressure system, in order to generate a constant or uniform spray pressure at the spray nozzles or spray nozzle units. Since the defined spray pressure is generated by the spray liquid delivery unit, the delivery units upstream from the buffer tank, i.e., the liquid delivery units and the active agent delivery unit, may be very simply designed, since they need only assume the task of feeding the liquid or the active agent into the buffer tank.

If the spray liquid delivery unit is integrated into the buffer tank, the buffer tank may be designed as a pressure accumulator, for example, including media demixing (spray liquid—air). The pressure regulation in the buffer tank may then take place via a pneumatic pressure regulator valve, so that potential pressure fluctuations in the system may be reduced. The spray liquid delivery unit is preferably, however, situated downstream from the spray liquid tank, as a result of which the buffer tank may be designed to be pressureless. In this case the buffer tank may be designed to be pressureless, for example, with the aid of a ventilation hole. The ventilation hole may include a ventilation valve. This means in other words that the buffer tank is fluidically connected, or is connectable at a defined internal pressure, to the surroundings so that it is designed to be pressureless. With this measure, the liquid delivery unit and the active agent unit need preferably no longer operate against the high system pressure but merely against the ambient pressure (and the counter pressure occurring due to losses of flow), so that the pressure requirements of the corresponding pumps or metering pumps are further reduced. The liquid delivery unit may, for example, include a simple flow pump or delivery pump, which has a pure in/out functionality. The required metered volume flow of the active agent may then be ascertained and the active agent metering pump may be activated via the volume flow signal and the previously adjusted mixing ratio in connection with a volumetric flow meter. Alternatively, the liquid delivery unit may include a metering pump having a fixed delivery ratio (without measurement of the delivered volume). It is also possible that the liquid delivery unit includes a simple valve or a proportional valve in connection with a volumetric flow meter and a constant pressure source in the liquid line. It is also possible that the liquid delivery unit includes a constant pressure source and a metering aperture. As an alternative to the metering pump, the active agent delivery unit may include a simple delivery pump in connection with a volumetric flow meter (regulation). The active agent delivery unit in this case may additionally include at least one metering aperture. The buffer storage may also be designed very simply and essentially with no static requirements, as a result of which the overall costs may be further reduced.

The spray nozzle unit includes in each case at least one spray nozzle for deploying the spray liquid and at least one valve for controlling or regulating the deployed quantity of spray liquid. Accordingly, the spray nozzle unit is designed to be controllable or actuatable, i.e., openable and closable. Each of the spray nozzle units is preferably separately activatable. The valve may be situated in or integrated into the spray nozzle. The valve may, however, also be situated in front of the spray nozzle, i.e., (in the flow direction of the spray liquid) upstream from the spray nozzle. The spray nozzle unit may, however, also include multiple spray nozzles, each including an upstream valve. The spray nozzle unit may further also include multiple spray nozzles including only one valve upstream from the spray nozzles, so that when actuating the valve, the spray liquid is deployed with the aid of all spray nozzles of the spray nozzle unit. Accordingly, the spray nozzle unit may be designed as a part-width section of a nozzle system. The spray nozzle unit may also include a final mixing unit, which is designed to intermix the spray liquid with the liquid and or with the active agent and/or with an additional active agent—which are conductable or feedable with the aid of corresponding lines to the final mixing unit. In this case, it is advantageous to provide a combination of the final mixing unit and the previously described mixing unit, which in this case would be designed as a pre-mixing unit, in order to obtain a two-stage mixing system.

The sensor units may each include one sensor element or one sensor or also multiple sensor elements or sensors. A sensor unit may be situated in a through-flow area. A through-flow area may be understood within the scope of the present invention to mean an area through which the spray liquid and/or the carrier liquid and or the active agent is/are flowable. In this case, it is accordingly an area, which comes into contact with the spray liquid and/or the carrier liquid and/or the active agent. A sensor unit in this case may be in direct contact with the spray liquid and/or the carrier liquid and/or the active agent or active agents, in order to detect the property information. The first sensor unit is situated preferably in the through-flow area of the carrier liquid. The through-flow area of the carrier liquid preferably includes the liquid line leading to the mixing unit and/or the liquid tank. The second sensor unit is situated preferably in the through-flow area of the spray liquid. The through-flow area of the spray liquid includes preferably the spray liquid line leading away from the mixing unit and/or the spray liquid tank. The third sensor unit is situated preferably in the through-flow area of the active agent. The through-flow area of the active agent includes preferably the active agent line leading from/to the mixing unit and/or the active agent tank. The sensor unit may, however, also be situated outside the through-flow area. In this case, the corresponding sensor unit may be designed to detect the property information of the spray liquid and/or of the carrier liquid and/or of the active agent in a contactless manner. In addition to the property information, the sensor unit may be designed to detect a temperature of the spray liquid and/or of the carrier liquid and/or of the active agent in the through-flow area. The sensor unit may include a transmission unit. The transmission unit may be designed to transmit or to send the property signal including the detected values or measured values of the property information wirelessly, for example, via radio, WLAN, Bluetooth, etc., and/or in a hardwired manner.

The property signals each include a detected piece of property information and a detected value/measured value of the property information. An active agent concentration in the spray liquid is ascertainable using the detected property information or the detected value of the property information. This means in other words that an active agent concentration in the spray liquid is (directly or indirectly) derivable from the property information. In particular, the property information of the spray liquid and the active agent concentration in the spray liquid are essentially uniquely a function of one another. The property information of the spray liquid and the active agent concentration in the spray liquid in this case may be a linear function of one another. Accordingly, it is possible to deduce the active agent concentration in the spray liquid with the aid of the detected property information and the detected value of the property information. The property information may be a physical and/or chemical and/or bodily and/or material property of the spray liquid. The detected property information is preferably selected from the group made up of: electrical property, in particular, electrical conductivity or permittivity, visual property, in particular, absorption property, emission property, fluorescence, sound velocity, or a combination thereof. In this way, it is possible with the aid of conventional computing methods to very easily ascertain an active agent concentration in the spray liquid. The detected pieces of property information of the spray liquid, of the carrier liquid and, if necessary, of the active agent, are the same. The detected pieces of property information are preferably the electrical conductivity.

Thus, for example, the electrical conductivity of a solution is a universal physical variable and indicates the ability of a material to conduct an electrical current. This conductivity is strongly a function of the quantity of dissolved salts, which are to be found either already in the active agents or in the spraying agents, or which could also be added to the active agent by the manufacturers or the farmers. Other physically measurable material variables, in addition to conductivity, may also be utilized for determining the concentration of the active agent. Thus, the clouding of the solution (and thus the absorption coefficient for light) also changes with the concentration of the active agent in water due to the proportion of undissolved particles in the solution, or also the sound velocity (in particular, as a function of the density and compressibility of the medium). There is also the possibility of deducing the concentration of the active agent, for example, via fluorescence measurements. Here, a type of tracer (for example, a dye) could also be added to the active agents.

The step of receiving the first property signal includes a step of ascertaining an actual value of the property information of the spray liquid.

The step of receiving the second property signal includes a step of ascertaining a base value of the property information of the carrier liquid. The detection of the property information of the supplied carrier liquid is carried out before the introduction of the active agent or the intermixing with the active agent. It is noted here that no ascertainment of an active agent concentration in the carrier liquid is carried out.

The step of outputting takes place as a function of the ascertained actual value of the property information of the spray liquid and of the ascertained base value of the property information of the carrier liquid. This means in other words that it is decided as a function of the ascertained actual value and of the ascertained base value whether a signal and/or what type of signal, if necessary, also including which content, is output. In this case, therefore, the actual base value of the carrier liquid is always taken as the basis of calculation and of decision-making without a conversion to an active agent concentration value taking place in the process. Instead, the base value is “factored out” of the actual value in order to thereby obtain a calibrated or adjusted value of the property information of the spray liquid and thus of the remaining actually contained active agent. The step of outputting the information signal and/or the control signal is accordingly carried out as a function of an active agent concentration in the carrier liquid. Thus, the step of outputting the information signal and/or the control signal is carried out under the assumption that the carrier liquid contains no active agent.

In this case, the actual value of the property information of the spray liquid is preferably compared in the step of outputting the information signal and/or the control signal with a setpoint value of the property information of the spray liquid, in order as a function thereof to output the information signal to the display unit and/or the control signal to the delivery unit. The setpoint value of the property information of the spray liquid is in turn ascertained preferably as a function of the base value of the property information of the carrier liquid and of a predefined or predefinable setpoint value of the active agent concentration in the spray liquid. The setpoint value of the property information of the liquid spray is further calculated or ascertained using the property information of the active agent. The value of the property information of the active agent in this case may be ascertained from stored characteristic curves or data sheets or else detected in the spray device.

The steps of receiving the property signal and of outputting the information signal and/or the control signal may be carried out with the aid of a control unit. The ascertainment or calculation of the active agent concentration in the spray liquid may also be carried out with the aid of the control unit and of conventional computing methods. A control unit in the present case may be understood to mean an electrical device, which processes sensor signals and outputs control signals and/or information signals/data signals as a function thereof. For this purpose, the control unit may include at least one processing unit for processing the property signals or pieces of property information. The processing unit may, for example, be a signal processor, a microcontroller or the like. The control unit may further include at least one memory unit for storing the property signals or pieces of property information or may be connected for this purpose to a memory unit. The memory unit may include a cloud server, a flash memory, an EPROM or a magnetic memory unit. The control unit may also include at least one communication interface for reading in the property signals and for outputting the information signals and/or the control signals. The communication interface may be designed to read in or output the signals wirelessly, for example, via radio, WLAN, Bluetooth, etc., and/or in a hardwired manner. The communication interface may be designed in hardware and/or in software. In a hardware design, the interface may, for example, be part of a so-called system ASIC, which contains a wide variety of functions of the control unit. It is also possible, however, for the interface to include dedicated integrated circuits or to be made at least partly of discrete components. In a software design, the interface may be a software module, which is present, for example, on a microcontroller alongside other software modules.

The control signal is designed to control or activate the delivery unit in such a way that the through-flow volume of the supplied carrier liquid and/or of the supplied active agent is reduced or increased as needed.

The information signal may include the value of the property information of the spray liquid, and may be designed to be displayed on the display unit. The display unit in this case may be a display, a smartphone or an arbitrary other terminal such as, for example, a tablet or a PC. The information signal may, for example, be selected from the list made up of: SMS, email, push-notification, telephone call. The term “adjust” encompasses within the scope of the present invention a regulating or a regulation of the active agent concentration.

The method for monitoring and/or adjusting an active agent concentration in a spray liquid to be deployed with the aid of a spray device, in particular, for agricultural purposes, an active agent and a carrier liquid being fed to a mixing unit of the spray device in order to blend the spray liquid, may accordingly include the following steps:
detecting a piece of property information of the blended spray liquid with the aid of a first sensor unit of the spray device, in order to ascertain an actual value of the property information of the spray liquid, an active agent concentration in the spray liquid being ascertainable using the property information;
detecting a piece of property information of the supplied carrier liquid with the aid of a second sensor unit of the spray device, in order to ascertain a base value of the property information of the carrier liquid; and
ascertaining and/or adjusting the active agent concentration in the spray liquid with the aid of a delivery unit of the spray device as a function of the ascertained actual value of the property information of the spray liquid and of the ascertained base value of the property information of the carrier liquid.

With the method according to the present invention and the spray device according to the present invention, it is now possible to carry out a very precise monitoring and adjustment of the active agent concentration in the spray liquid. This in turn enables the use of cost-efficient delivery pumps instead of highly accurate metering pumps. The precise monitoring and adjustment is enabled, in particular, by the fact that a value of the property information, for example, the electrical conductivity of the supplied carrier liquid, is ascertained, which is taken as a base value for the entire calculation and therefore control. In this case, there is no conversion to a concentration, but rather this base value of the carrier liquid is “factored out” of the actual value of the spray liquid in order to thereby obtain a calibrated or adjusted value of the property information of the spray liquid without carrier liquid and thus, the remaining actually contained active agent. This value may then be compared with a desired or required value, for example, in order as a function thereof, to carry out the adjustment or regulation of the active agent concentration.

It is also advantageous if in an additional step of receiving a third property signal including the property information of the supplied active agent detected with the aid of a third sensor unit of the spray device, in order to ascertain a base value of the property information of the active agent, and further to monitor and/or to adjust the active agent concentration in the blended spray liquid as a function of the base value of the property information of the active agent. In this case, it is particularly advantageous if also the setpoint value of the property information of the spray liquid is further ascertained as a function of the base value of the property information of the active agent. For these embodiments, the spray device may include a third sensor unit for detecting a piece of property information of the supplied active agent. With this measure, it is possible—instead of the calculation with the aid of stored characteristic curves—to ascertain the actual present base value of the active agent, so that the entire calculation and thus the method may be even more precisely carried out.

It is also advantageous if the actual value and/or the setpoint value of the property information of the spray liquid is/are ascertained using a temperature of the spray liquid detected by the first sensor unit and/or the base value of the property information of the carrier liquid is detected using a temperature of the carrier liquid detected with the aid of the second sensor unit and/or the base value of the property information of the active agent is detected using a temperature of the active agent detected with the aid of the third sensor unit. In this case, it is particularly advantageous if the temperature is detected at the point at which the corresponding property information is also detected. Since the temperature generally has an influence on the property information (conductivity, density, etc.), the method may be even more precisely carried out by taking this factor into consideration in the detection or ascertainment of the property information and/or of the active agent concentration.

For the detection of the property information with the aid of absorption, it is possible, similar to the temperature, to also measure the pressure, so that for this purpose the sensor unit may alternatively or additionally include a pressure sensor. In addition, it is advantageous if in the step of ascertaining, the actual value of the property information of the spray liquid located in a spray liquid tank situated downstream from the mixing unit is ascertained, the blended spray liquid being deployed from the spray liquid tank. In this case, it is particularly advantageous if in the step of outputting the control signal, the delivery unit is overridden in a targeted manner, in order to more rapidly adjust the active agent concentration in the spray liquid located in the spray liquid tank. It is also advantageous if an additional actual value of the property information of spray liquid located upstream from the spray liquid tank is further ascertained, the active agent concentration in the spray liquid to be deployed being further adjusted as a function of the additional actual value of the property information. In this case, the first sensor unit may also include a volumetric flow sensor in order to detect the volume of spray liquid flowing into the spray liquid tank. With this measure, it is possible to avoid undesirable larger deviations of the active agent concentration.

Accordingly, an example method sequence could appear, for example, as follows:
1. measuring the electrical conductivity of the carrier liquid and of the active agent
2. potentially measuring or ascertaining (based on stored characteristic curves or data sheets) the electrical conductivity of the active agent
3. ascertaining the setpoint value of the electrical conductivity of the spray liquid based on the specification of the setpoint concentration
4. measuring the electrical conductivity of the spray liquid and determining the deviation from the setpoint value
5. readjusting the pumps, i.e., the carrier liquid pump or the active agent pump
6. potentially defined overriding of the pumps to adjust the active agent concentration in the spray liquid tank
7. storing the control parameters of the pumps

### BRIEF DESCRIPTION OF THE DRAWINGS

The present invention is explained by way of example in greater detail below with reference to the figures.

FIG. 1 schematically shows a representation of one exemplary embodiment of the spray device.

FIG. 2 schematically shows a representation of the control unit.

FIG. 3 shows a diagram of the active agent concentration profile when the pumps are overridden.

FIG. 4 shows a flow chart of a method for monitoring and/or adjusting the active agent concentration.

### DETAILED DESCRIPTION OF EXAMPLE EMBODIMENTS

In the following description of preferred exemplary embodiments of the present invention, identical or similar reference numerals are used for elements which are represented in the various figures and act similarly, a repeated description of the elements being omitted.

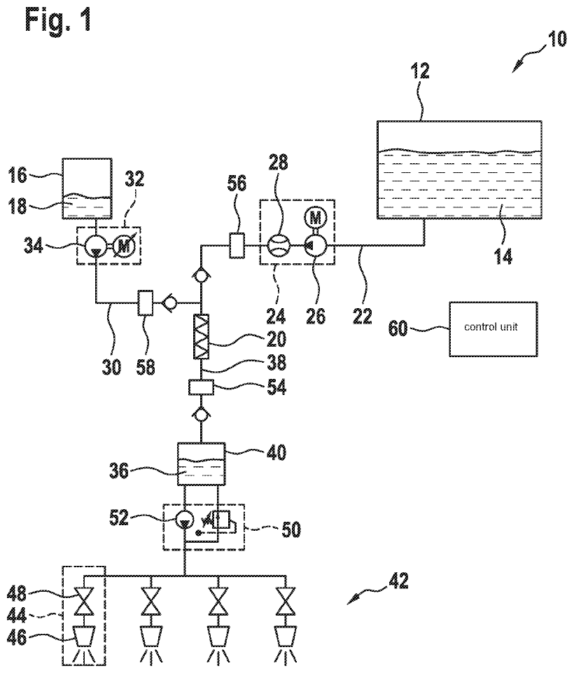

A schematic representation of a spray device is depicted in FIG. 1, which is provided in its entirety with reference numeral 10.

Spray device 10 includes a liquid tank 12 including a carrier liquid 14 and an active agent tank 16 including an active agent 18. Carrier liquid 14 is water 14.

Spray device 10 further includes a static mixing unit 20. Static mixing unit 20 is fluidically connected to liquid tank 12 via a liquid line 22. A liquid delivery unit 24 is situated in liquid line 22 in order to be able to feed or conduct carrier liquid 14 to static mixing unit 20. Liquid delivery unit 24 in this case includes a delivery pump 26 and a volumetric flow meter 28. Similarly, static mixing unit 20 is further connected to active agent tank 16 via an active agent line 30. In turn, an active agent delivery unit 32 is situated in active agent line 30, in order to be able to feed or conduct active agent 18 to static mixing unit 20. Acting agent delivery unit 32 in this case includes a metering pump 34. Accordingly, active agent 18 is intermixed with carrier liquid 14 with the aid of static mixing unit 20 to form a spray liquid 36.

In order to achieve a greater metering bandwidth with a higher metering accuracy, a spray liquid tank 40 is situated in a spray liquid line 38 downstream from static mixing unit 20. Spray liquid tank 40 in this case is designed as a buffer tank 40. Spray liquid tank 40 or buffer tank 40 is situated and designed in such a way that spray liquid 36 is poured from static mixing unit 20 into spray liquid tank 40, in order to then be conducted from spray liquid tank 40 to a nozzle system 42 including spray nozzle units 44. Each of spray nozzle units 44 includes a spray nozzle 46 for deploying spray liquid 36 and a valve 48 for controlling or regulating the deployed quantity of spray liquid.

To adjust the spray pressure at the spray nozzle units 44, spray device 10 further includes a spray liquid delivery unit 50, which is designed to feed spray liquid 36 from spray liquid tank 40 under pressure or under a defined pressure to nozzle system 42, or to spray nozzle units 44. Spray liquid delivery unit 50 in this case includes a constant pressure source including a pump 52.

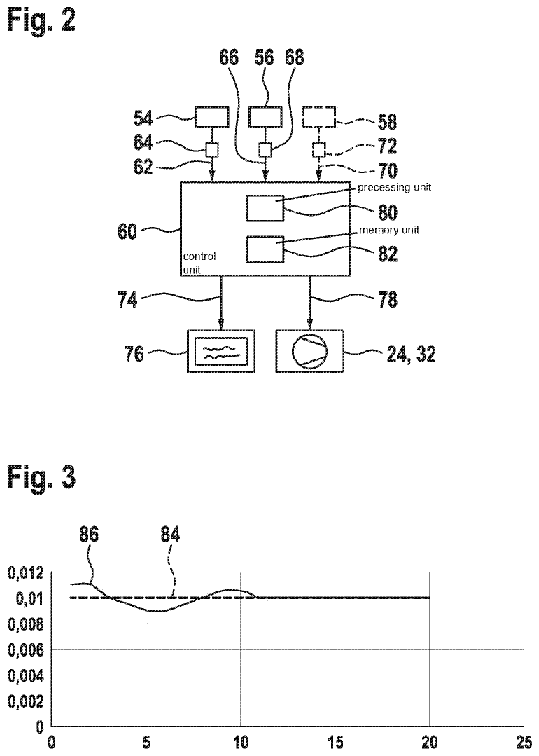

In order to then be able to monitor and/or adjust the active agent concentration in spray liquid 36, spray device 10 further includes a first sensor unit 54, a second sensor unit 56 and a third sensor unit 58 and a control unit 60. First sensor unit 54 is situated in spray liquid line 38 downstream from mixing unit 20. First sensor unit 54 is designed in this case to detect a piece of property information of blended spray liquid 36. Second sensor unit 56 is situated in liquid line 22 downstream from liquid tank 12. Second sensor unit 56 is designed in this case to detect a piece of property information of carrier liquid 14. Third sensor unit 58 is situated in active agent line 30 downstream from active agent tank 16. Third sensor unit 58 is designed in this case to detect a piece of property information of active agent 18. In FIG. 2, it is explained below how the monitoring and adjustment or regulation of the active agent concentration with the aid of control unit 60 takes place.

As is more readily apparent from FIG. 2, control unit 60 is configured to receive a first property signal 62 including a piece of property information 64 of spray liquid 36 detected with the aid of first sensor unit 54 of spray device 10. Control unit 60 is further configured to receive a second property signal 66 including a piece of property information 68 of carrier liquid detected with the aid of second sensor unit 56. Control unit 60 is also configured to receive a third property signal 70 including a piece of property information 72 of active agent 18 detected with the aid of third sensor unit 58 of spray device 10. The pieces of property information 64, 68, 72 in this case each include an electrical conductivity and a temperature. Accordingly, sensor units 54, 56, 58 each include one sensor for detecting the electrical conductivity and one sensor for detecting the temperature. Control unit 60 is also configured to output an information signal 74 to a display unit 76 and a control signal 78 to delivery unit 24, 32 as a function of the pieces of property information 64, 68, 72, in order to monitor and/or adjust the active agent concentration in spray liquid 36. In this case, control unit 60 is configured to carry out the calculations with the aid of a processing unit 80 and to activate delivery units 24, 32 accordingly. Control unit 60 further includes a memory unit 82 for storing the values of the pieces of property information 64, 68, 72.

FIG. 3 shows the active agent concentration profile in the case of a defined overriding of delivery units 24, 32 for adjusting the active agent concentration in spray liquid 36 in spray liquid tank 40. The active agent concentration is represented in % (y-axis) over time units (x-axis), dashed line 84 representing the setpoint active agent concentration and line 86 representing the adjusted active agent concentration of spray liquid 36 in spray liquid tank 40. In the example shown, spray liquid tank 40 is filled within 20 time units, the desired final concentration of 0.01% being achieved already after 11 time units.

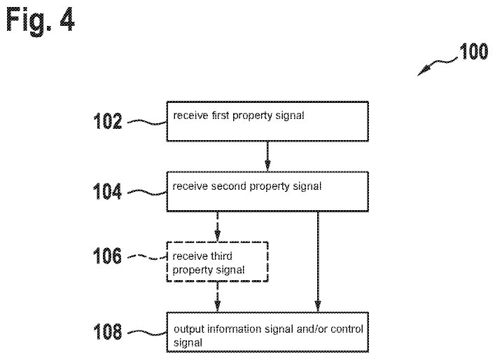

FIG. 4 shows a flow chart of a method 100 for monitoring and/or adjusting an active agent concentration in a spray liquid 36 to be deployed with the aid of a spray device 10, in particular, for agricultural purposes, an active agent 18 and a carrier liquid 14 being fed to a mixing unit 20 of spray device 10 in order to blend spray liquid 36. Method 100 includes a step 102 of receiving a first property signal 62 including a piece of property information 64 of blended spray liquid 36 detected with the aid of a first sensor unit 54 of spray device 10, in order to ascertain an actual value of property information 64 of spray liquid 36, an active agent concentration in spray liquid 36 being ascertainable using property information 64. Method 100 also includes a step 104 of receiving a second property signal 66 including property information 68 of supplied carrier liquid 14 detected with the aid of a second sensor unit 56 of spray device 10, in order to ascertain a base value of property information 68 of carrier liquid 14. Finally, method 100 includes a step 108 of outputting an information signal 74 to a display unit 76 and/or a control signal 78 to a delivery unit 24, 32 of spray device 10 as a function of the ascertained base value of property information 68 of carrier liquid 14, in order to monitor and/or adjust the active agent concentration in blended spray liquid 36. Method 100 optionally also includes a step 106 of receiving a third property signal 70 including property information 72 of supplied active agent 18 detected with the aid of a third sensor unit 58 of spray device 10, in order to ascertain a base value of property information 72 of active agent 18, and further to monitor and/or adjust the active agent concentration in blended spray liquid 36 as a function of the base value of property information 72 of active agent 18

If an exemplary embodiment includes an “and/or” linkage between a first feature and a second feature, this is to be read in the sense that the exemplary embodiment according to one specific embodiment includes both the first feature and the second feature, and according to another specific embodiment, either only the first feature or only the second feature.

1-17. (canceled)

18. A method for monitoring and/or adjusting an active agent concentration in a spray liquid to be deployed using a spray device, for agricultural purposes, an active agent and a carrier liquid being supplied to a mixing unit of the spray device to blend the spray liquid, the method comprising the following steps:
receiving a first property signal including a piece of property information of the blended spray liquid detected using a first sensor unit, to ascertain an actual value of the property information of the spray liquid, an active agent concentration in the spray liquid being ascertainable using the property information;
receiving a second property signal including a piece of property information of the supplied carrier liquid detected using a second sensor unit of the spray device, to ascertain a base value of the property information of the carrier liquid; and
outputting an information signal to a display unit and/or a control signal to a delivery unit of the spray device, the information signal and/or the control signal being output as a function of the ascertained actual value of the property information of the spray liquid, and as a function of the ascertained base value of the property information of the carrier liquid, to monitor and/or to adjust the active agent concentration in the blended spray liquid.

19. The method as recited in claim 18, further comprising the following step:
receiving a third property signal including property information of the supplied active agent detected using a third sensor unit of spray device, to ascertain a base value of the property information of the active agent and to monitor and/or adjust the active agent concentration in the blended spray liquid further as a function of the base value of the property information of the active agent.

20. The method as recited in claim 18, wherein the step of outputting the information signal to the display unit and/or the control signal to the delivery unit is carried out regardless of an active agent concentration in the carrier liquid.

21. The method as recited in claim 18, wherein the step of outputting the information signal to the display unit and/or the control signal to the delivery unit is carried out under an assumption that the carrier liquid contains no active agent.

22. The method as recited in claim 18, wherein in the step of outputting the information signal and/or the control signal, the actual value of the property information of the spray liquid is compared with a setpoint value of the property information of the spray liquid, and the outputting of the information signal to the display unit and/or the control signal to the delivery unit is a function of the comparison.

23. The method as recited in claim 22, wherein the setpoint value of the property information of the spray liquid is ascertained as a function of the base value of the property information of the carrier liquid and as a function of a predefined setpoint value of the active agent concentration in the spray liquid.

24. The method as recited in claim 23, wherein the setpoint value of the property information of the spray liquid is further ascertained as a function of the base value of the property information of the active agent.

25. The method as recited in claim 19, wherein the actual value and/or the setpoint value of the property information of the spray liquid is ascertained using a temperature of the spray liquid detected using the first sensor unit and/or the base value of the property information of the carrier liquid is ascertained using a temperature of the carrier liquid detected using the second sensor and/or the base value of the property information of the active agent is ascertained using a temperature of the active agent detected using the third sensor unit.

26. The method as recited in claim 18, wherein the delivery unit includes a liquid delivery unit which is configured to feed the carrier liquid from a liquid tank to the mixing unit in a defined manner, and an active agent delivery unit which is configured to feed the active agent from an active agent tank to the mixing unit in a metered manner, to adjust the active agent concentration in the blended spray liquid.

27. The method as recited in claim 18, wherein the actual value of the property information of the spray liquid located in a spray liquid tank situated downstream from the mixing unit is ascertained, the blended spray liquid being deployed from the spray liquid tank.

28. The method as recited in claim 27, wherein in the outputting step, the control signal is output to the delivery unit, the delivery unit being overridden in a targeted manner to more rapidly adjust the active agent concentration in the spray liquid located in the spray liquid tank.

29. The method as recited in claim 28, wherein an additional actual value of the property information of the spray liquid located in front of the spray liquid tank is further ascertained, the active agent concentration in the spray liquid o be deployed being adjusted further as a function of the additional actual value of the property information.

30. The method as recited in claim 18, wherein the detected pieces of property information include one of more of the following: an electrical property including electrical conductivity or permittivity, a visual property, an absorption property, an emission property, fluorescence, a sound velocity.

31. A control unit configured to monitor and/or adjust an active agent concentration in a spray liquid to be deployed using a spray device, for agricultural purposes, an active agent and a carrier liquid being supplied to a mixing unit of the spray device to blend the spray liquid, the control device configured to:
receive a first property signal including a piece of property information of the blended spray liquid detected using a first sensor unit, to ascertain an actual value of the property information of the spray liquid, an active agent concentration in the spray liquid being ascertainable using the property information;
receive a second property signal including a piece of property information of the supplied carrier liquid detected using a second sensor unit of the spray device, to ascertain a base value of the property information of the carrier liquid; and
output an information signal to a display unit and/or a control signal to a delivery unit of the spray device, the information signal and/or the control signal being output as a function of the ascertained actual value of the property information of the spray liquid, and as a function of the ascertained base value of the property information of the carrier liquid, to monitor and/or to adjust the active agent concentration in the blended spray liquid.

32. A spray device for deploying a spray liquid for agricultural purposes, comprising:
a mixing unit configured to blend a spray liquid from a carrier liquid supplied to the mixing unit using a liquid delivery unit, and an active agent supplied using an active agent delivery unit;
a first sensor unit configured to detect a piece of property information of the blended spray liquid, an active agent concentration in the spray liquid being ascertainable using the property information;
a second sensor unit configured to detect a piece of property information of the supplied carrier liquid; and
a control unit configured to monitor and/or adjust the active agent concentration in the spray liquid to be deployed, the control device configured to:
receive a first property signal including the piece of property information of the blended spray liquid detected using the first sensor unit, to ascertain an actual value of the property information of the spray liquid;
receive a second property signal including the piece of property information of the supplied carrier liquid detected using the second sensor unit of the spray device, to ascertain a base value of the property information of the carrier liquid; and
output an information signal to a display unit and/or a control signal to the delivery unit of the spray device, the information signal and/or the control signal being output as a function of the ascertained actual value of the property information of the spray liquid, and as a function of the ascertained base value of the property information of the carrier liquid, to monitor and/or to adjust the active agent concentration in the blended spray liquid.

33. A non-transitory machine-readable memory medium on which is stored a computer program for monitoring and/or adjusting an active agent concentration in a spray liquid to be deployed using a spray device, for agricultural purposes, an active agent and a carrier liquid being supplied to a mixing unit of the spray device to blend the spray liquid, the computer program, when executed by a computer, causing the computer to perform the following steps:
receiving a first property signal including a piece of property information of the blended spray liquid detected using a first sensor unit, to ascertain an actual value of the property information of the spray liquid, an active agent concentration in the spray liquid being ascertainable using the property information;
receiving a second property signal including a piece of property information of the supplied carrier liquid detected using a second sensor unit of the spray device, to ascertain a base value of the property information of the carrier liquid; and
outputting an information signal to a display unit and/or a control signal to a delivery unit of the spray device, the information signal and/or the control signal being output as a function of the ascertained actual value of the property information of the spray liquid, and as a function of the ascertained base value of the property information of the carrier liquid, to monitor and/or to adjust the active agent concentration in the blended spray liquid.
